(19) United States
(12) Patent Application Publication
(10) Pub. No.: US 2005/0163911 A1
(43) Pub. Date: Jul. 28, 2005

(54) Animal feed product containing crushed urea

(75) Inventors: Scott S. McGowen, Baldwinsville, NY (US); Brent A. Shonka, Riverview, FL (US)

Correspondence Address: Scott T. Piering;Cargill, Inc., Law Department, P.O. Box 5624, Minneapolis, MN, 55440-5624, US

(73) Assignee: Cargill, Inc.

(21) Appl. No.: 10/765,213

(22) Filed: Jan. 28, 2004

(51) Int. Cl. A23L 1/20

(52) U.S. Cl. 426/630

(57) ABSTRACT

The present invention is related to an animal feed product for ruminant animals containing urea as a source of non-protein nitrogen and a method for forming the same. The animal feed product includes urea which has been crushed from a large size prill or granule prior to pelleting with other animal feed components. The resulting composition has improved storage and processing properties.

### BACKGROUND OF THE INVENTION

The present invention relates generally to the field of animal feed products and methods for producing the same.

The present invention relates to animal feed and feed supplements, particularly ruminant animal feeds and feed supplements containing protein and protein equivalent nitrogen which releases at a slow and substantially even rate in the rumen of cattle, sheep, or other ruminating animals.

Ruminant animals such as cows, sheep, and goats form a special class of animals because of their digestive systems. Ruminants have a complex stomach which consists of several compartments. The first compartment, known as the rumen, contains numerous microorganisms which break down ingested proteins and amino acids into other compounds, such as ammonia.

A ruminant animal's nutritional requirements generally are provided by forages, grains, and other known feed stuffs. Pelleted feed supplements, however, are commonly used to provide nutritional fortification to the diets of ruminant animals, especially beef cattle in feedlots or dairy cows. These feed supplements generally have an organic component and inorganic component. The primary purpose of the feed supplement is to provide the animal with proteins, vitamins, and minerals. The inorganic portion of the feed supplement frequently provides the animal with minerals and the organic portion frequently provides the animal with protein and vitamins.

Ruminant animals have the ability to utilize non-protein nitrogenous compounds through the symbiotic relationship with the microorganisms in their rumen and reticulum that convert the non-protein nitrogenous compounds into protein which, in turn, can be digested and absorbed by the animal. It is also known that a portion of the protein requirements for ruminant animals can be provided by urea. Urea is the most common synthetic nitrogen compound fed to ruminants. Urea is degraded to ammonia and carbon dioxide very rapidly by the urease enzymes present in the rumen. The substitution of urea for traditional sources of protein has provided cost savings in the formulation of ruminant animal feed.

Ruminants, such as feedlot cattle, may require a relatively high level of supplementation in their diets. Hence, pelleted supplements tend to contain a high level of particulate ingredients such as urea. It is desirable to provide a method of increasing the efficiency and the rate production of pelletized feeds for ruminant animals, especially feeds which include a large portion of particulates such as urea and minerals.

One method of producing solid urea particulates is granulation or accretion. This method provides for the initial generation of small seed particles and increases of such particles to the predetermined product size by gradual external addition; fusion and/or inclusion of thin layers (coating) of like material in the form of concentrated solutions and/or melts. The granulation processes normally utilize a rotating drum or pan which is designed to form a cascading bed or curtain of recycled undersize and seed particles onto which the urea solution or molten urea is sprayed wherein accretion takes place. Urea particulates as granules produced by any of several commercial granulation processes usually have favorable characteristics for storing, handling, incorporating into bulk blends, and direct application to the field.

Unfortunately, urea is very hygroscopic and quickly incorporates water to form large blocks or masses which effects the flowability of the animal feed product. As such, the incorporation of the hygroscopic urea in animal feed products has led to feed mixes and finished pellets that have poor storage characteristics, poor process characteristics, and poor flowability. One solution has been to treat the animal feed product containing urea with additional drying or conditioning agents such as clays. However, these methods have increased the cost of the animal feed product and frequently have resulted in dusty finished products.

Another solution to overcome the hygroscopic nature of urea was to replace urea by it less hygroscopic, but more expensive, auto condensation product. This has been found to be both economically costly and nutritionally lacking.

Yet another solution to overcome the hygroscopic nature of urea in animal feed products, as discussed in U.S. Pat. No. 3,416,928, is to use an animal feed grade micro-prilled form of urea. Prilled urea are small, round, spherical urea particles that are made by solidifying free-falling urea droplets in air or a fluid medium.

The practice of the art of urea prilling utilizes a tall enclosed tower. Urea in the form of a highly concentrated solution or melt is pumped to or otherwise introduced at the top of the tower where the urea solution or melt is formed into droplets and allowed to free fall to the bottom of the tower through an upward-directed cooling airflow which solidifies the solution or melt into solid particles or prills. Urea prills from commercial prilling processes are usually relatively small in size, less dense, and suffer from low hardness and high friability when compared to particulates produced from granulation processes.

Prilled urea is generally produced in two grades, fertilizer grade prilled urea and animal feed grade micro-prilled urea. Fertilizer grade prilled urea typically has a particle size diameter of from about 1 millimeters to about 4 millimeters. On the other hand, animal feed grade micro-prilled urea typically has a particle size diameter from about 0.4 millimeters to about 1.5 millimeters. While both fertilizer grade prilled urea and animal feed grade micro-prilled urea have the same chemical make-up, formulating the animal feed grade micro-prilled urea to the required size in the enclosed tower prilling apparatus for pelleting in an animal feed product makes the animal feed grade micro-prilled urea somewhat more expensive than the fertilizer grade prilled urea. On the other hand, the fertilizer grade prilled urea is too large for processing into an animal feed product. Moreover, the particle size of the fertilizer grade prilled urea is not attractive for use in an animal feed product. Thus, the animal feed grade micro-prilled urea has been used for animal feed products. However, the animal feed grade micro-prilled urea can be expensive to make and/or purchase, thus adding to the cost of the animal feed or animal feed supplement.

The present invention relates to urea-containing pelletized feed products for ruminant animals and the production of such pelletized feeds. More particularly, this invention is directed to increasing the efficiency of production including the rate of production of such feeds, increasing the non-protein nitrogen (“NPN”) content of such feeds while improving or maintaining the flowability of such feeds when the feeds are subjected to material handling conditions.

It is desirable to provide a pelletized feed product with an increased NPN content utilizing urea and a method for providing such a feed with an increased NPN content. It also is desirable to provide a pelletized feed product which includes urea and a method for improving the flowability of urea-containing pelletized feed.

### SUMMARY OF THE INVENTION

One embodiment of the present invention relates to providing an animal feed product and a method for preparing the animal feed product which releases protein equivalents slowly and effectively utilizes urea without danger of toxicity, which has good storage characteristics, and which does not require the use of animal feed grade micro-prilled urea.

It is an object of this invention to provide a method of preparing ruminant feed products which release crude protein equivalent slowly and provide improved nutrition for ruminant animals.

It is still another object of this invention to provide an effective and economical method for producing efficacious feed products for ruminant animals.

This invention relates generally to the field of animal nutrition and more particularly to feedstuffs of increased crude protein content for ruminant animals. Still more specifically, the invention relates to improving the ruminant nutritional value of poor quality plant materials having a relatively low crude protein content.

In accordance with the invention, a method is provided for preparing a ruminant feed composition by grinding or crushing a urea product, such as, for example, a fertilizer grade prilled urea or granular urea product, and combining the crushed urea product together with conventional animal feed product components to form an animal feed product. The urea product is crushed from a urea product having a larger average particle size to a urea product having a smaller average particle size, thereby providing a composition with a safe and controlled release of crude protein equivalent nitrogen when ingested by ruminant animals and which is suitable for use as a ruminant feed supplement, particularly as a protein supplement, or as a complete ruminant feed.

The product may be used in meal form as a total ruminant ration or it may be blended with other ruminant feeds to form a complete ration. Another method for use, which is particularly useful where the ruminant feed product, either as a supplement or a total ration, is to be shipped, is the formation of pellets by compressing the meal at high pressure.

### BRIEF DESCRIPTION OF THE DRAWINGS

FIG. 1 is a micrographic image showing micro-prilled urea.

FIG. 2 is a micrographic image showing crushed urea retained on a 35-mesh screen.

FIG. 3 is a micrographic image showing crushed urea retained on a 60-mesh screen.

FIG. 4 is a micrographic image showing crushed urea fines.

FIG. 5 is a micrographic image showing crushed urea that fell through a 45-mesch screen but collected on a 60-mesh screen.

FIG. 6 is a graph showing the particle diameter compared with particle roundness for crushed urea and micro-prilled urea.

FIG. 7 is a graph showing the particle diameter compared with aspect ratio for crushed urea and micro-prilled urea.

FIG. 8 is a scanning electron microscopy image showing micro-prilled urea.

FIG. 9 is a scanning electron microscopy image showing crushed urea.

FIG. 10 is a schematic figure showing a process according to the present invention.

### DETAILED DESCRIPTION OF THE PREFERRED EMBODIMENTS

Definitions:

Fertilizer grade urea means a prilled or granular urea having a particle size diameter of from about 1 millimeters to about 4 millimeters. Fertilizer grade urea is often sold for use in agricultural applications. One example of commercially available fertilizer grade urea is sold by Agrium Inc., Calgary, Alberta, Canada in both prilled and granular form.

Animal feed grade micro-prilled urea means a substantially round/spherical prilled urea having a particle size diameter from about 0.4 millimeters to about 1.5 millimeters. Animal feed grade micro-prilled urea is often sold for use as an animal feed. One example of an animal feed grade micro-prilled urea or similar product is commercially available from Agrium Inc., Borger, Tex.

Animal feed supplement means a feed supplement for feeding to animals. The animal feed supplement includes the crushed urea according to the present invention and may also include one or more animal feed ingredients.

Animal feed ingredients means grain products, plant protein products, animal protein products, roughage products, and/or vitamin and mineral supplements.

Animal feedstuff means a low crude protein animal feed ingredient. Animal feedstuff may be found on farms and may include fermented, natural, synthetic, or waste products from the agricultural industry. The animal feedstuff can be mixed with the animal feed supplement according to the present invention to form the animal feed product.

Animal feed product means the combination of an animal feed supplement, animal feed ingredients, and animal feedstuffs that represents the complete diet fed to the animal. The animal feed product may be formed by mixing an animal feed supplement with an animal feedstuff.

Complete animal feed product means an animal feed product formed as a complete feed by mixing the crushed urea according to the present invention and at least one animal feed supplement and/or animal feed ingredients to form a complete feed. It should be noted that the components of the animal feed supplement, including urea, may be combined directly into a complete animal feed product along with other animal feed ingredients and animal feedstuffs without the need for manufacturing an independent animal feed supplement.

When the specification refers to percentages of different components it should be understood that the percentages are on a weight basis unless otherwise noted.

In one embodiment, the present invention is useful for increasing the effective crude protein content of various agricultural residues, animal roughages, or animal feedstuffs of relatively low crude protein content. The ruminant animal feed supplement of the present invention may be conveniently incorporated with conventional animal feedstuff and animal ingredient components and constitute up to 60 percent or more of a ruminant animal's diet.

The resultant animal feed product is obtained by mixing the animal feed supplement of the present invention with a low crude protein animal feedstuff and other animal feed ingredients such that the resultant combination contains 5 to 40 weight % crude protein, preferably from about 8 to 32 weight % crude protein, most preferably from about 12 to 25 weight % crude protein. Protein equivalents, such as urea, may be used to supply a portion of the crude protein in the animal feed product. The amount of protein equivalents used depends upon the animal feed ingredients and feedstuffs used in the process and the end use intended for the animal feed product. This protein equivalent may be adjusted to the desired level by simply controlling the ratio of animal feed supplement, animal feedstuff, and other animal feed ingredients fed to the animal.

The animal feedstuff portion of the animal feed may be selected from fermented, natural, synthetic, or waste products from the agricultural industry. Animal feedstuffs may include but are not limited to: corn silage, grass haylage, alfalfa haylage, steam flaked corn, alfalfa hay, grass hay, animal production wastes, fruit wastes, vegetable processing wastes, green chop plant products, fermented milk products, brewery wastes, and human food waste. The animal feedstuff is mixed with the animal feed supplement and animal feed ingredients according to the present invention to form an animal feed product.

According to the present invention, the animal feed supplement makes up from about 0.5 to about 60% or more of the ruminant animal's diet. Preferably, the animal feed supplement according to the present invention makes up from about 1 to about 50% of the ruminant animal's diet. More preferably, the animal feed supplement according to the present invention makes up from about 1.5 to about 25% of the ruminant animal's diet.

The animal feed supplement may include but is not limited to:
1. Grain products such as corn, sorghum, wheat, grain screenings, wheat middling, distillers grains, rice bran, and corn gluten feed and the like;
2. Urea as a non-protein nitrogen source;
3. Plant protein products, such as soybean meal, linseed meal, canola meal, bean meal, cottonseed meal, sunflower meal, peanut meal, corn gluten meal, and the like;
4. Animal protein products, such as meat and bone meal, blood meal, and feather meal, poultry byproducts, and the like;
5. Roughage products, such as alfalfa hay, grass hay, oat hulls, cottonseed hulls, and soybean hulls and the like; and
6. Vitamin and mineral supplements, such as calcium carbonate, magnesium carbonate, potassium chloride, copper sulfate, zinc oxide, zinc sulfate, copper chloride, iron oxide, iron sulfate, manganese oxide, cobalt carbonate, ammonium sulfate, calcium sulfate, monocalcium phosphate, dicalcium phosphate, sodium chloride, magnesium oxide, riboflavin, biotin, pantothenic acid, thiamin, vitamin B₆, niacin, vitamin B₁₂, folic acid, vitamin A, vitamin C, vitamin D, vitamin E, vitamin K, and the like.

It should be understood that the animal feed supplement may include mixtures of each of the above components in amounts sufficient for an animal feed product for a particular type of animal. In addition, the animal feed supplement may include from 1.5 to 250% crude protein. One of skill in the art will understand that because urea contains a greater percentage of nitrogen than does protein, the animal feed supplement may include up to 250% crude protein based on the content of the urea in the animal feed supplement. The urea may contribute from 0.5% to 100% of the crude protein in the animal feed supplement.

Nonetheless, as a general guide, the urea is generally present in the final animal feed product in an amount from about 0.1 to about 2% by weight of the animal feed product, preferably from about 0.25 to about 1.75% by weight of the animal feed product, most preferably from about 0.5 to about 1.5% of the animal feed product. However, the inclusion rate of urea in the animal feed product is dependent upon adequate energy available for microbial growth in the rumen. Levels of energy that meet this criteria could be described as about 0.75 to about 2% by weight total diet sugar for every 0.04 kg of urea in the animal feed product or about 2 to about 5% starch for every 0.04 kg of urea in the animal feed product.

The animal feed supplement preferably includes a combination of vitamin and mineral supplements in an amount from about 1 to about 50% by weight of the animal feed supplement, preferably from about 5 to about 40% by weight of the animal feed supplement, most preferably from about 7 to about 35% of the animal feed supplement.

The animal feed supplement and resultant animal feed product preferably include a plant protein product in an amount of from about 0 to about 60% by weight of the animal feed supplement or animal feed product. The animal feed supplement and resultant animal feed product preferably include an animal protein in an amount from about 0 to about 20% by weight of the animal feed supplement or animal feed product.

In another embodiment, the present invention is useful for preparing a complete animal feed. The complete ruminant animal feed of the present invention may be formed into a complete feed by mixing the crushed urea together with at least one animal feedstuff and/or animal feed ingredient component. The resultant complete animal feed may constitute up to 100 percent of a ruminant animal's diet.

Protein equivalents, such as urea, may be used to supply a portion of the crude protein in the animal feed product. The amount of protein equivalents used depends upon the animal feed ingredients and feedstuffs used in the process and the end use intended for the animal feed product.

The complete animal feed product preferably includes plant protein product in an amount from about 0 to about 60% by weight of the complete animal feed product. The complete animal feed product preferably includes animal protein product in an amount from about 0 to about 20% by weight of the complete animal feed product.

The complete animal feed product preferably includes a combination of vitamin and mineral supplements in an amount from about 1 to about 50% by weight of the animal feed supplement, preferably from about 5 to about 40% by weight of the animal feed supplement, most preferably from about 7 to about 35% of the complete animal feed product.

The urea to be added to the animal feed supplement and the animal feed products according to the present invention is preferably crushed prior to being combined with the remaining animal feed supplement components. The urea starting material can be any large particle urea, such as, for example, a granular urea product or a fertilizer grade prilled urea. The urea starting material has a particle size of about 1 millimeters or greater.

The urea starting material can be ground, crushed, rolled, or the like in any appropriate mechanical apparatus. For example, the urea starting material can be crushed in a roller mill, a hammer mill, a jaw crusher, or the like. Preferably, the urea starting material is crushed in a roller mill. Any known apparatus can be used in the present invention. One example of a commercially suitable roller mill is the Roskamp Champion SPRM1200-36 roller mill.

In order to crush the urea starting material, the gap width between the rollers in the roller mill can be set to about 0.015 inches to about 0.060 inches, more preferably from about 0.020 inches to about 0.050 inches, most preferably between about 0.025 inches to about 0.040 inches.

The urea starting material is crushed such that the urea final product to be incorporated into the animal feed supplement has an average particle size of from about 0.4 millimeters to about 2.5 millimeters. Preferably, the urea incorporated into the animal feed supplement has an average particle size of from about 0.5 millimeters to about 1.65 millimeters. More preferably, the urea incorporated into the animal feed supplement has an average particle size of from about 0.55 millimeters to about 1.4 millimeters. Most preferably, the urea incorporated into the animal feed supplement has an average particle size of from about 0.6 millimeters to about 1.2 millimeters.

Another way to determine the particle size of the crushed urea product is to determine the size of the particles by sieving. It should be understood that when crushing the urea starting material the resultant material is not crushed to an entirely uniform particle size. Instead, the resultant material has a particle size distribution such that a certain percentage of the material will pass through a first larger size sieve while being retained on a second smaller size sieve. Likewise, another percentage of the material will pass through the second sieve while being retained on a third incrementally smaller sized sieve. The size ranges of the particle sizes according to the present invention are set forth in the table below:

| Mesh Size | | | |
|---|---|---|---|
| (Tyler Mesh) | Particle Size (mm) | | % Retained |
| 10 | >1.68 | mm | 0-10 |
| 12 | 1.42-1.68 | mm | 0-35 |
| 14 | 1.20-1.41 | mm | 10-50 |
| 16 | 1.01-1.19 | mm | 1-75 |
| 20 | 0.85-1.00 | mm | 1-75 |
| 24 | 0.72-0.84 | mm | 1-75 |
| 28 | 0.60-0.71 | mm | 1-50 |
| 35 | 0.43-0.59 | mm | 1-25 |
| | ≦0.42 | mm | 0-20 |

Once the urea particles have been crushed, they lose the spherical and round character of the prilled urea. Sphericity has been defined as the degree to which a particle approaches a spherical shape. It is measured as the ratio between the diameter of a sphere with the same volume as the particle and the diameter of the circumscribed sphere.

Then v=(π/6)LIS and the volume of the circumscribing circle is v=(π/6)L³
Sphericity is defined as

$$ψ = \sqrt{\frac{SI}{{L}^{2}}}$$

where L is the long axis of the particle, I is the intermediate axis of the particle and S is the short axis of the particle.

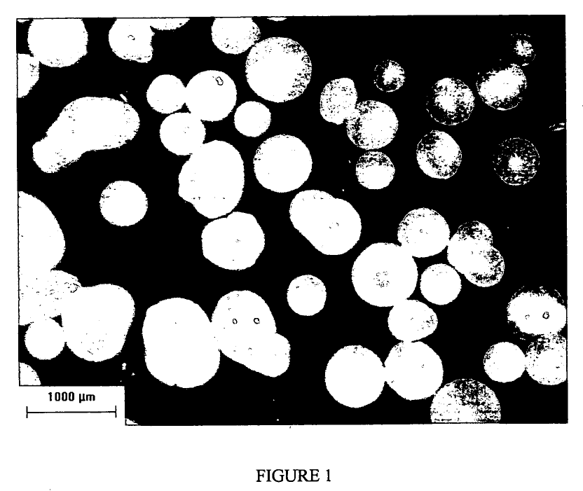

According to the present invention, the urea particles added to the animal feed supplement are less spherical than the animal feed grade micro-prilled urea. As can be seen in FIG. 1, the animal feed grade micro-prilled urea are small, nearly spherical aggregates of urea. The sphericity, ψ, of the animal feed grade micro-prilled urea is typically in the range of from about 0.85 to about 1.0. In contrast, the crushed urea particles of the present invention are non-spherical and are more angular or subangular with rough jagged edges and have a sphericity, ψ, of about 0.05 to about 0.65.

Roundness is defined as the degree of abrasion of a particle as shown by the sharpness of its edges and corners. In 1932, Wadell expressed roundness as the ratio of the average radius of curvature of the several edges or corners of a particle to the radius of curvature of the maximum inscribed sphere. Mathematically, Waddell defined Waddell roundness as:

$$ρ = ( \frac{1}{n} {\sum }_{I = 1}^{n} {r}_{i} ) \frac{1}{R}$$

where r is the radius of curvature of all convex corners of the grain margin, and ER is the radius of the largest inscribed circle. Again with reference to FIGS. 1-8, the well rounded animal feed grade micro-prilled urea has a roundness, ρ, of about 0.80 to 1.00. In contrast, the crushed urea according to the present invention typically has a roundness, ρ, of about 0.05 to 0.25.

FIGS. 1-5 are light-based images which were created using a digital camera equipped with a macro lens. Magnifications were determined using a magnification calibration standard.

Image analysis was done using ImagePro Plus™ v.4.5 image analysis software. When analyzing images, the software calculations were calibrated using a magnification calibration standard. Any particles partly obscured by the border of the micrograph were not counted during the analysis process. The resulting data was transferred to an appropriate plotting program for visualization and interpretation. Each Particle Diameter was calculated by ImagePro™ based upon several diameter measurements, each taken at two-degree intervals, which pass through the object's centroid. These diameters were then averaged to produce that particle's average diameter. Thus, each diameter data point should be considered a “mean diameter” for its respective particle.

Aspect Ratios are calculated by ImagePro™ based upon the ratio between the major axis (length) and the minor axis (width) of an ellipse equivalent to the particle's two-dimensional morphology apparent within the micrograph. An aspect ratio of one therefore has identical length and width measurements. Any particle with unequal length and width measurements will have an aspect ratio larger than one.

Particle Roundness is calculated using the following formula:

$$\frac{{perimeter}^{2}}{4 \times π \times area} .$$

A particle with a roundness of one is considered by ImagePro™ to be perfectly round. Any particle with roundness larger than one is thus out-of-round. Sieving or screening was done with a series of screen mesh sizes ranging from 35-mesh to 60-mesh. It should be understood that the values for particle roundness calculated by ImagePro™ differ from the values for particle roundness using the Waddell roundness calculation discussed above.

FIG. 1 shows animal feed grade micro-prilled urea. As can be seen from the figure, the particles are mostly spherical (or round as seen within the two-dimensional image).

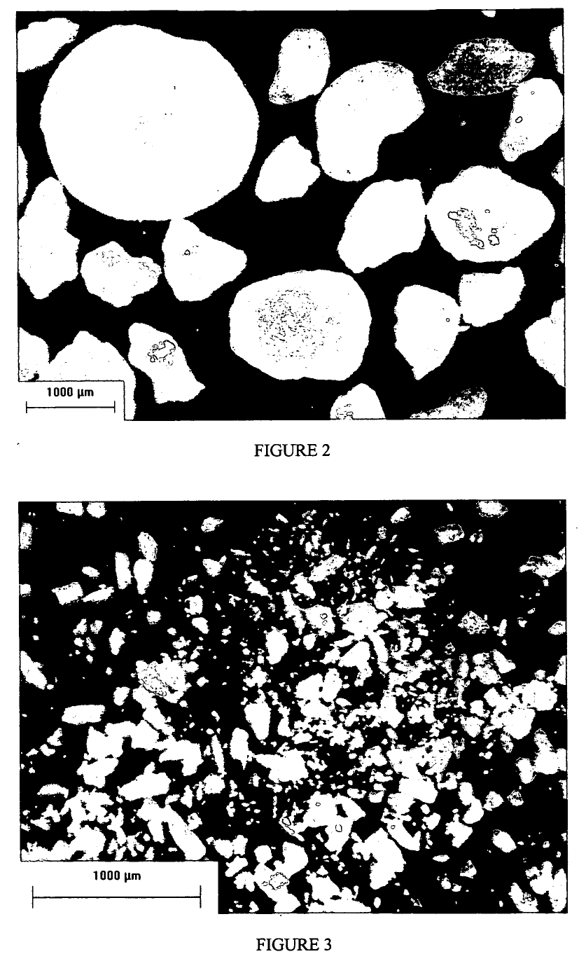

FIG. 2 displays shows crushed urea particles which are retained on a 35-mesh screen. As can be seen from the figure, most particles display a fractured morphology. Because the analysis program could not distinguish individual particles with the sample in its as-received condition, the sample was sieved or screened to eliminate fines existing within this sample in abundance. Thus, the crushed urea particles are shown in FIGS. 2-5.

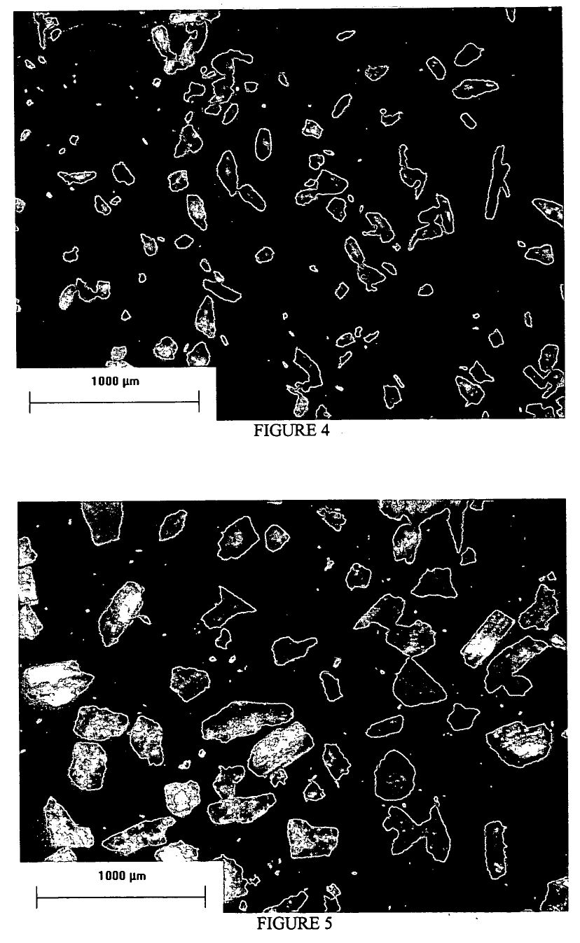

The crushed particles were passed through a 35-mesh and 60-mesh screens. FIG. 2 shows the crushed retained on a 35-mesh screen. FIG. 3 shows the crushed urea retained on a 60-mesh screen. FIG. 4 shows the crushed urea fines. FIG. 5 shows the crushed urea retained that passed through a 45-mesh screen but collected on a 60-mesh screen. FIGS. 2-5 show that the crushed urea particles are much less spherical and much less round than the animal feed grade micro-prilled urea.

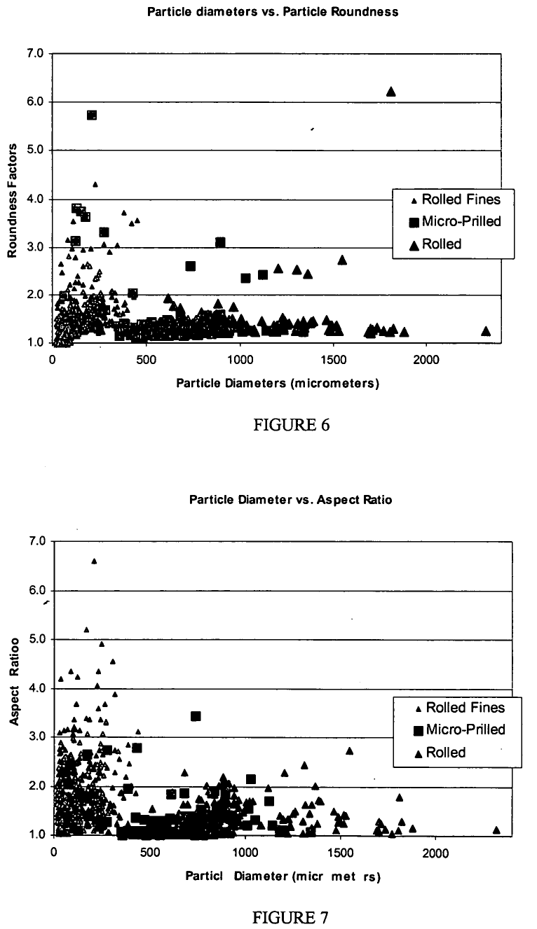

Reference is now made to FIGS. 6-7. FIG. 6 is a plot of the relative particle “roundness” as a function of particle average diameter. In this figure, relative particle roundness is considered where a roundness factor of 1 is considered by the analysis programming to be a perfectly round particle. In FIG. 6, the small size region (<300 microns) of both samples exhibits a wide range of particle roundness, and both samples have a few very non-round particles among the larger particles. However, the average roundness for the majority of the crushed urea particles is greater than that for the animal feed grade micro-prilled urea.

FIG. 7 shows the particle aspect ratio plotted against average particle diameter. An Aspect Ratio of “1” represents a particle that is perceived by the analysis program to have minimum and maximum diameters that are equal.

Aspect Ratios, plotted within FIG. 7, display differences between crushed urea of the present invention and the animal feed grade micro-prilled urea particles in two regions: The 400-900 micrometer size range and the 0-400 micrometer size range. The animal feed grade micro-prilled urea particles tend to have Aspect Ratios close to 1, and a tight distribution within the 400-900 size range, while the crushed urea particles display greater variability. Within the 0-400 size range, the crushed urea fines show a very large variation, when compared to the animal feed grade micro-prilled urea. Thus, it is shown that the two sample populations do not have the same size or roundness characteristics. Therefore, the two samples are morphologically “different”.

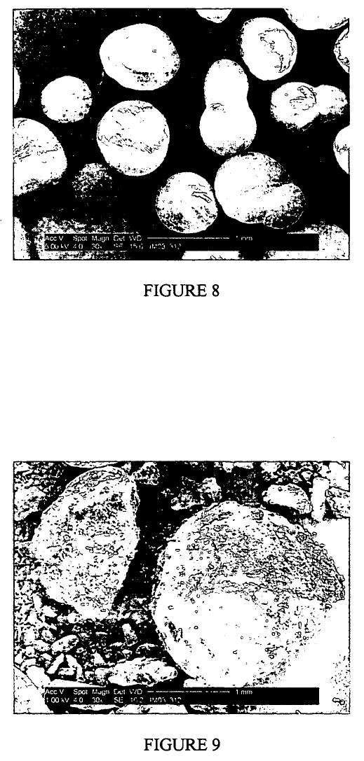

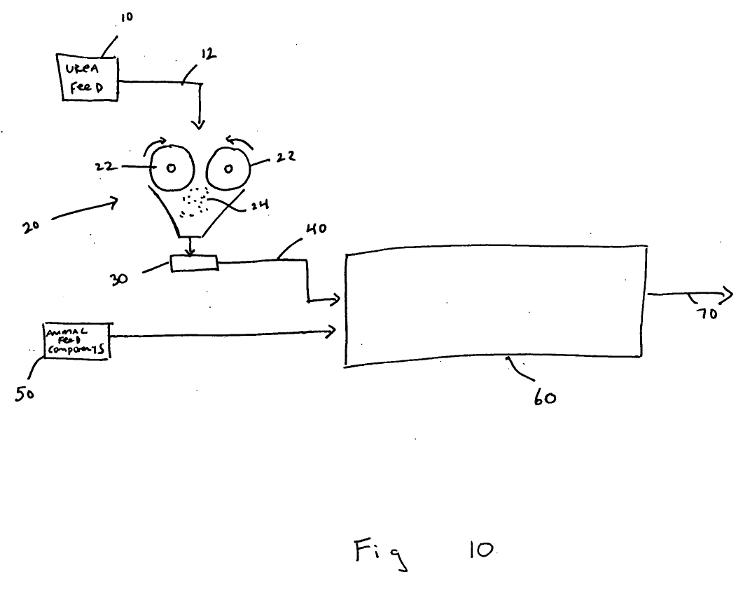

Reference is now made to FIGS. 8-9. Scanning Electron Microscope (SEM) images were created with a Phillips environmental SEM in standard SEM mode. Samples were sputter-coated with a gold/palladium alloy to assist in grounding the associated charge build-up created by the electron beam. The metal coating is only a few tens of nanometers thick, and therefore does not alter the apparent morphology or size of the imaged particles.

For the case of the animal feed grade micro-prilled urea sample (FIG. 8), few if any fines were observed. Occasional fractured particles are seen, but most are relatively intact. However, the crushed urea sample (FIG. 9) display a wide range of particle sizes and shapes, which appear to be associated with its processing. The vast majority display fractured morphology. The larger particles are coated with some of the smaller fines and are seen against a bed of smaller particles. The image shows the presence of relatively few larger particles when compared to the abundance of fines.

Reference is made to FIG. 10, which shows a schematic process according to the present invention. The urea starting material 10 is fed to a crushing/grinding apparatus 20 through transport means 12. The crushing/grinding apparatus 20 may be roller mill, a hammer mill, a jaw crusher or the like but is depicted as a roller mill. The crushing/grinding apparatus 20 has two rollers 22 which crush the urea starting material to a predetermined size. The gap between the rollers 22 can be set to any predetermined width depending upon the desired size of the crushed urea. The crushed urea 24 is mixed with animal feed ingredients 50 and fed into an animal feed apparatus 60. The crushed urea 24 may be optionally sized by a screen 30 or may fed directly into the animal feed apparatus 60.

The animal feed supplement may be in pellet form and preferably of a small size, so that many types of livestock are able to utilize the feed. Further, it is preferred, as a matter of livestock economics, that the feedstuff be flowable, so that automatic feeders may be employed. Thus, the granules of a granular feedstuff must not tend to agglomerate. Typical sized pellets that are suitable include pellet diameters from 0.125 inches to 0.75 inches and pellet lengths from 0.25 inches to 3 inches.

The animal feed apparatus 60 may include any known apparatus for forming an animal feed product. This type of apparatus is well known to the person having ordinary skill in the art and may include other apparatus equipment, for example, a pellet mill, an extruder, a briquetting apparatus, an expander, a fluidized-bed type granulator, a flow type granulator, a rotary-plate type granulator, or the like.

In order to form a pelletized product, a pellet die is typically employed. The pelletization die may be a cylinder with a plurality of holes in its curved walls with one or more rollers pushing the feed through the holes in the curved walls. A blade nips the pellets as they exit the holes. A more complete description of known pelletization equipment can be found in Feed Manufacturing Technology, American Feed Industry Association, Inc., Arlington, Va., Vol. IV 1994, Ch. 10, pp. 111-130, which is incorporated herein by reference. It should be understood that the product may also be formed by expansion, extrusion or any other method for forming animal feeds.

The pelletized feed supplement or product is made by mixing the crushed urea 24 with the animal feed ingredients 50 in a mixer, such as, for example a ribbon mixer, to achieve homogeneous mixing. The animal feed ingredients 50 may include grain products, plant protein products, animal protein products, roughage products, and vitamin and mineral supplements, or combinations thereof. The mixture may then be conveyed to a conditioning chamber where steam may be introduced to achieve a feed or meal conditioning temperature of from about 100 to about 250° F. Then the warmed feed is dropped into a pelletizing die, or similar agglomeration equipment such as an extruder, and formed into pellets. For ease of production and to produce the desired size, a binder such as lignin, wheat powder or molasses may be employed. Thereafter, the warm pellets drop directly from the pellet mill into a cooler and are cooled using ambient air to within 10° F. of ambient temperature. The cooled pellets may then be discharged and conveyed to a storage bin for eventual use 70. The pelleted animal food product may be in pellets of generally cylindrical form with a circular or square cross section with a thickness of between 2 to 20 millimeters and a length of 5 to 80 millimeters.

The feed product, thus obtained, is a dry, free-flowing product composed of particles ranging from about 100 microns to 2000 microns in diameter. The range of particle size can be somewhat wider when feedstuffs with significant fibrous material contents are used as starting materials.

It should be further understood that it is possible in the present invention to keep the temperature relatively low, while performing admixture and granulation, so that nutrients such as vitamins in the basic nutritional material, which may not be heat stable, and useful microbes contained in the basic nutritional material are not destroyed. Typical “low” temperatures are from about ambient temperature to 130° F. For example, many vitamins, enzymes, and probiotics, beneficial in animal feedstuffs have weak resistance to heat. It is understood that the present invention can be formulated to protect these optional components in the animal feed product.

Animal feed products and animal feed supplements according to the present invention may also be produced in the form of expanded granules, which are commonly prepared by subjecting powdery materials to high temperature and pressure, for example in an extruder or expander wherein the powdery materials are moistened with water or steam at elevated temperature and at a pressure of between 20 to 30 Kg/cm³ and then extruded from the pressurized atmosphere into ambient atmosphere through a perforated die plate. Products in granular form may also be prepared by pulverizing or sifting solid products or by binding powdery materials by blowing or spraying water or other binders thereon. The process is suitably carried out in a granulating machine of the fluidized-bed, rotary drum or rotary plate type and the binder to be used may include, for example, alpha-starch, carboxy-alpha-starch, carboxymethylcellulose (CMC), gelatin, guar-gum, sodium casein, or gum arabic.

It should also be understood that the animal feed products and animal feed supplements according to the present invention may include any suitable additives such as, for example, a fatty component. The fatty component may be a suitable vegetable oil such as soybean oil, corn oil, cottonseed oil, sesame oil and olive oil, or animal fats such as suet, lard, tallow and grease or other fats. These fatty components may be available in powder form. The oils and fats may be used alone or in combination. The fatty component may be supplied in its natural state if fluid. If it is semi-solid at ambient temperature, it may be melted by heating. The fatty component may be added to the animal food product by itself, or may be mixed with water or with a feedstuff material containing water, such as molasses, corn steep liquor and the like in the presence of a suitable emulsifier such as fatty acid monoglyceride, sugar ester, polyoxyethylenesorbitester or lecithin, which emulsifier may be added directly to the powdery material for the feedstuff.

The invention also contemplates a pelletized animal feed product where the prepelletized feed blend comprises the crushed urea and animal feed ingredients without the need for manufacturing an independent animal feed supplement prior to combination with animal feed ingredients and animal feedstuffs for production of the animal feed product.

### EXAMPLES

In order that those skilled in the art may better understand the compositions of the present invention and the methods in which they are formed and used, the following examples are given. The examples serve to further illustrate the present invention but are not intended to limit it thereto.

### Example 1

A fertilizer grade prilled urea having an average particle size of about 2.5 millimeters was crushed in a roller mill with a gap between the rollers set to be about 0.030 inches. The table below illustrates the particle size distribution for the resultant crushed urea product.

| | | | | % Retained |
|---|---|---|---|---|
| Mesh Size | | | % Retained Urea | Urea After |
| (Tyler Mesh) | Particle Size (mm) | | Before Crushing | Crushing |
| 9 | >2.00 | mm | 28.82% | 0.16% |
| 10 | 1.69-2.00 | mm | 46.66% | 1.89% |
| 12 | 1.42-1.68 | mm | 19.52% | 9.39% |
| 14 | 1.20-1.40 | mm | 3.18% | 12.79% |
| 16 | 1.01-1.19 | mm | 0.93% | 21.64% |
| 20 | 0.85-1.00 | mm | 0.33% | 16.51% |
| 28 | 0.60-0.84 | mm | 0.28% | 15.16% |
| 35 | 0.43-0.58 | mm | 0.14% | 6.58% |
| | ≦0.42 | mm | 0.15% | 15.87% |

### Example 2

A fertilizer grade prilled urea having an average particle size of about 2.5 millimeters was crushed in a roller mill with a gap between the rollers set to be about 0.030 inches. The table below illustrates the particle size distribution for the resultant crushed urea product.

| | | | | % Retained |
|---|---|---|---|---|
| Mesh Size | | | % Retained Urea | Urea After |
| (Tyler Mesh) | Particle Size (mm) | | Before Crushing | Crushing |
| 9 | >2.00 | mm | 35.94% | 0.2% |
| 10 | 1.69-2.00 | mm | 51.03% | 1.06% |
| 12 | 1.42-1.68 | mm | 9.92% | 0.77% |
| 14 | 1.20-1.40 | mm | 1.88% | 18.93% |
| 16 | 1.01-1.19 | mm | 0.69% | 23.59% |
| 20 | 0.85-1.00 | mm | 0.31% | 21.76% |
| 28 | 0.60-0.84 | mm | 0.11% | 15.13% |
| 35 | 0.43-0.58 | mm | 0.04% | 4.72% |
| | ≦0.42 | mm | 0.08% | 13.84% |

### Examples 3-5

Animal feed product containing urea produced by the process for crushing urea as set forth in Example 2 was compared to animal feed products containing animal feed grade micro-prilled urea. In the inventive examples, the animal feed product included the crushed urea product according to Example 2. The crushed urea product was formed by crushing fertilizer grade prilled urea having a particle size of approximately 2.5 millimeters particle size in a roller mill. In the respective comparative examples, the animal feed product contained the commercially available animal feed grade micro-prilled urea commercially available from Agrium, Inc.

### Example 3 and Comparative Example 3

A pelleted animal feed supplement was prepared which included the following components:

| Example 3 Animal Feed | % |
|---|---|
| Urea | 18.45 |
| Animal Protein Product | 0 |
| Plant Protein Product | 51.20 |
| Vitamin & Mineral Supplement | 30.35 |
| Total | 100 |

The only difference between the exemplified composition and the comparative exampled was that the exemplified composition included the crushed urea according to Example 2 while the comparative exampled a commercially available animal feed micro-prilled urea was added to the formulation. As can be seen from the information below, the crushed urea according to the present invention achieved an 11.63% increase in throughput in the pelleting process as compared to the exact same composition using a commercially available animal feed micro-prilled urea.

| | Average Tons | Percent Increase In |
|---|---|---|
| Feed | Per Hour | Productivity |
| Comparative | 10.75 | |
| Example 3 | | |
| Example 3 | 12.00 | 11.63% |

### Example 4 and Comparative Example 4

A pelleted animal feed supplement was prepared which included the following components:

| Example 4 Animal Feed | % |
|---|---|
| Urea | 14.45 |
| Animal Protein Product | 11.60 |
| Plant Protein Product | 47.15 |
| Vitamin & Mineral Supplement | 26.80 |
| Total | 100 |

The only difference between the exemplified composition and the comparative exampled was that the exemplified composition included the crushed urea according to Example 2 while the comparative exampled a commercially available animal feed micro-prilled urea was added to the formulation. As can be seen from the information below, the crushed urea according to the present invention achieved an 8.87% increase in throughput in the pelleting process as compared to the exact same composition using a commercially available animal feed micro-prilled urea.

| | Average Tons Per | Percent Increase In |
|---|---|---|
| Feed | Hour | Productivity |
| Comparative | 10.93 | |
| Example 2 | | |
| Example 2 | 11.90 | 8.87% |

### Example 5 and Comparative Example 5

A pelleted animal feed supplement was prepared which included the following components:

| Example 5 Animal Feed | % |
|---|---|
| Urea | 11.65 |
| Animal Protein Product | 11.0 |
| Plant Protein Product | 45.10 |
| Vitamin & Mineral Supplement | 32.25 |
| Total | 100 |

The only difference between the exemplified composition and the comparative exampled was that the exemplified composition included the crushed urea according to Example 2 while the comparative exampled a commercially available animal feed micro-prilled urea was added to the formulation. As can be seen from the information below, the crushed urea according to the present invention achieved a 10.7% increase in throughput in the pelleting process as compared to the exact same composition using a commercially available animal feed micro-prilled urea.

| | Average Tons Per | Percent Increase |
|---|---|---|
| Feed name | Hour | In Productiviy |
| Comparative | 10.75 | |
| Example 5 | | |
| Example 5 | 11.90 | 10.70% |

The finished pellets showed excellent storage properties. Moreover, the crushed urea animal feed products showed significant increases in the pellet production rates as compared to the use of conventional animal feed grade micro-prilled urea.

1. A method for making a pelleted animal feed supplement comprising:
crushing a solid urea product having an average particle size of at least 2.5 millimeters to form a crushed urea having an average size of from about 0.4 millimeters to about 2.0 millimeters;
adding said crushed urea to at least one animal feed ingredient and
forming said pelleted animal feed supplement.

2. The method according to claim 1, wherein said crushed urea has an average particle size of between about 0.6 millimeters to about 1.65 millimeters.

3. The method according to claim 1, wherein said crushed urea has an average particle size of between about 0.7 millimeters to about 1.5 millimeters.

4. The method according to claim 1, wherein said at least one animal feed ingredient is selected from the group consisting of grain products, plant protein products, animal protein products, roughage products, and vitamin and mineral supplements, and mixtures thereof.

5. The method according to claim 1, wherein the crushing of said solid urea product is performed in a roller mill.

6. The method according to claim 1, wherein said solid urea product is a fertilizer grade prilled urea product.

7. The method according to claim 6, wherein said fertilizer grade prilled urea product has a particle size of between 2.5 millimeters and 5 millimeters.

8. The method according to claim 1, wherein said solid urea product is a fertilizer grade granular urea product.

9. A method for making an animal feed product comprising:
crushing a solid urea product having an average particle size of at least 2.5 millimeters to form a crushed urea having an average size of from about 0.4 millimeters to about 2.0 millimeters;
adding said crushed urea to at least one animal feed ingredient;
forming a pelleted animal feed supplement product; and
mixing said pelleted animal feed supplement product with an animal feedstuff product.

10. The method according to claim 9, wherein said crushed urea has an average particle size of between about 0.6 millimeters to about 1.65 millimeters.

11. The method according to claim 9, wherein said crushed urea has an average particle size of between about 0.7 millimeters to about 1.5 millimeters.

12. The method according to claim 9, wherein said at least one animal feed ingredient is selected from the group consisting of grain products, plant protein products, animal protein products, roughage products, and vitamin and mineral supplements, and mixtures thereof.

13. The method according to claim 9, wherein said animal feedstuff product is selected from the group consisting of corn silage, grass haylage, alfalfa haylage, steam flaked corn, alfalfa hay, grass hay, animal production wastes, fruit wastes, vegetable processing wastes, green chop plant products, fermented milk products, brewery wastes, and human food waste.

14. The method according to claim 13, wherein said animal feedstuff product is selected from the group consisting of corn silage, grass or alfalfa haylage, steam flaked corn, alfalfa or grass hay.

15. The method according to claim 9, wherein the crushing of said solid urea product is performed in a roller mill.

16. The method according to claim 9, wherein said solid urea product is a fertilizer grade prilled urea product.

17. The method according to claim 16, wherein said fertilizer grade prilled urea product has a particle size of between about 2.5 millimeters and about 5 millimeters.

18. The method according to claim 9, wherein said solid urea product is a fertilizer grade granular urea product.

19. A method for making a complete animal feed product comprising:
crushing a solid urea product having an average particle size of at least 2.5 millimeters to a crushed urea having an average size of from about 0.4 millimeters to about 2.0 millimeters;
adding said crushed urea to at least one animal feed ingredient; and
forming a complete animal feed product.

20. The method according to claim 19, wherein said crushed urea has an average particle size of between about 0.6 millimeters to about 1.65 millimeters.

21. The method according to claim 19, wherein said crushed urea has an average particle size of between about 0.7 millimeters to about 1.5 millimeters.

22. The method according to claim 19, wherein said at least one animal feed ingredient is selected from the group consisting of grain products, plant protein products, animal protein products, roughage products, and vitamin and mineral supplements, and mixtures thereof.

23. The method according to claim 19, wherein the crushing of said solid urea product is performed in a roller mill.

24. The method according to claim 19, wherein said solid urea product is a fertilizer grade prilled urea product.

25. The method according to claim 19, wherein said fertilizer grade prilled urea product has a particle size of between about 2.5 millimeters and about 5 millimeters.

26. The method according to claim 19, wherein said solid urea product is a fertilizer grade granular urea product.

27. A pelleted animal feed supplement comprising:
at least one animal feed ingredient and
a solid urea pelleted with said at least one animal feed supplement ingredient, wherein said urea has an average particle size from about 0.4 millimeters to about 2 millimeters, and further wherein said urea is not a micro-prilled urea.

28. The composition according to claim 27, wherein said solid urea has an average particle size of between about 0.6 millimeters to about 1.65 millimeters.

29. The composition according to claim 27, wherein said solid urea has an average particle size of between about 0.7 millimeters to about 1.5 millimeters.

30. The composition according to claim 27, wherein said at least one animal feed supplement ingredient is selected from the group consisting of grain products, plant protein products, animal protein products, roughage products, and vitamin and mineral supplements, and mixtures thereof.

31. The composition according to claim 27, wherein said solid urea is present in an amount of from about 0.5 to about 100% by weight of said pelleted animal feed supplement.

32. The composition according to claim 27, wherein said solid urea contributes between 0.5 to 100% of the total crude protein of said pelleted animal feed supplement.

33. The composition according to claim 27, wherein said solid urea has a sphericity, ψ, of from about 0.05 to about 0.65.

34. The composition according to claim 27, wherein said solid urea has a Waddell roundness, ρ, of from about 0.05 to about 0.25.

35. The composition according to claim 27, wherein said solid urea product has a sphericity, ψ, of from about 0.05 to about 0.65 and a Waddell roundness, ρ, of from about 0.05 to about 0.25.

36. The composition according to claim 27, wherein said animal feed supplement is a ruminant animal feed supplement.

37. An animal feed comprising:
at least one animal feed ingredient;
a solid urea pelleted with said animal feed supplemental ingredient to form a pelleted animal feed supplement product, wherein said urea has an average particle size from about 0.4 millimeters to about 2 millimeters, and wherein said solid urea is not a micro-prilled urea; and
an animal feedstuff product mixed with said pelleted animal feed supplement product.

38. The composition according to claim 37, wherein said solid urea has an average particle size of between about 0.6 millimeters to about 1.65 millimeters.

39. The composition according to claim 37, wherein said solid urea has an average particle size of between about 0.7 millimeters to about 1.5 millimeters.

40. The composition according to claim 37, wherein said at least one animal feed supplement ingredient is selected from the group consisting of grain products, plant protein products, animal protein products, roughage products, and vitamin and mineral supplements, and mixtures thereof.

41. The composition according to claim 37, wherein said animal feedstuff product is selected from the group consisting of corn silage, grass haylage, alfalfa haylage, steam flaked corn, alfalfa hay, grass hay, animal production wastes, fruit wastes, vegetable processing wastes, green chop plant products, fermented milk products, brewery wastes, and human food waste.

42. The composition according to claim 41, wherein said animal feedstuff product is selected from the group consisting of corn silage, grass haylage, alfalfa haylage, steam flaked corn, alfalfa hay, and grass hay.

43. The composition according to claim 37, wherein said solid urea is present in an amount of from about 0.5 to about 100% by weight of said pelleted animal feed supplement.

44. The composition according to claim 37, wherein said solid urea has a sphericity, ψ, of from about 0.05 to about 0.65.

45. The composition according to claim 37, wherein said solid urea has a Waddell roundness, ρ, of from about 0.05 to about 0.25.

46. The composition according to claim 37, wherein said solid urea product has a sphericity, ψ, of from about 0.05 to about 0.65 and a Waddell roundness, ρ, of from about 0.05 to about 0.25.

47. The composition according to claim 37, wherein said animal feed is a ruminant animal feed.

48. A complete animal feed comprising:
at least one animal feed ingredient; and
a solid urea combined with said animal feed ingredient to form a complete animal feed product, wherein said urea has an average particle size from about 0.4 millimeters to about 2 millimeters, and wherein said solid urea is not a micro-prilled urea.

49. The animal feed according to claim 48, wherein said solid urea has an average particle size of between about 0.6 millimeters to about 1.65 millimeters.

50. The animal feed according to claim 48, wherein said solid urea has an average particle size of between about 0.7 millimeters to about 1.5 millimeters.

51. The animal feed according to claim 48, wherein said at least one animal feed ingredient is selected from the group consisting of grain products, plant protein products, animal protein products, roughage products, and vitamin and mineral supplements, and mixtures thereof.

52. The animal feed according to claim 48, wherein said solid urea is present in an amount of from about 0.1 to about 2% by weight of said animal feed product.

53. The animal feed according to claim 48, wherein said solid urea has a sphericity, ψ, of from about 0.05 to about 0.65.

54. The animal feed according to claim 48, wherein said solid urea has a Waddell roundness, ρ, of from about 0.05 to about 0.25.

55. The animal feed according to claim 48, wherein said solid urea has a sphericity, ψ, of from about 0.05 to about 0.65 and a Waddell roundness, ρ, of from about 0.05 to about 0.25.

56. The animal feed according to claim 48, wherein said complete animal feed product is pelleted.
